(19) United States
(12) Patent Application Publication
(10) Pub. No.: US 2008/0301238 A1
(43) Pub. Date: Dec. 4, 2008

(54) METHOD AND SYSTEM FOR CONTROLLING EMAIL ADDRESS ACCOUNTS

(76) Inventor: DOUGLAS S. ELBERS, Reese, MI (US)

Correspondence Address: Irving M. Weiner;Weiner & Burt, P.C., 635 N. US-23, P.O. Box 186, Harrisville, MI, 48740, US

(21) Appl. No.: 11/756,309

(22) Filed: May 31, 2007

(51) Int. Cl. G06F 15/16

(52) U.S. Cl. 709/206

(57) ABSTRACT

A business owner of controlled email addresses sells access to email addresses for a specific amount of time or number of messages. An approved sender transmits an email message. A server receives the incoming email message. A business ID framework matches approved sender to approved receiver and forwards results to the server, If the email message is approved, then it is delivered to the approved receiver. The business may share a percent of the net income generated by address sales with receivers.

### CROSS-REFERENCE TO RELATED APPLICATIONS

Not Applicable

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The present invention generally relates to a novel and unique method and system for controlling email address accounts.

More particularly, the present invention relates to a novel and unique method and system for controlling email address accounts whereby a business owner of controlled email address accounts sells access to email addresses for a specific amount of time and/or a specific number of email messages.

The prior, but not necessarily relevant, art is exemplified by:

Shuster United States Patent Application Publication No. US 2002/0023135, entitled “ADDRESSEE-DEFINED MAIL ADDRESSING SYSTEM AND METHOD”, which discloses a mail delivery system and method that is suitable for implementation in the context of an email or similar electronic messaging system to manage and/or discourage unsolicited junk mail;

Jensen United States Patent Application Publication No. US 2005/0240432, entitled “METHOD AND SYSTEM TO ENABLE, TO ORGANIZE, TO FACILITATE, AND TO TRANSACT COMMUNICATIONS FOR A FEE OR COST BORN(E) BY A SENDER PARTY (ALSO KNOWN AS A CALLER PARTY) UTILIZING A NETWORK SUCH AS THE INTERNET”;

Enyart United States Patent Application Publication No. US 2006/0041505, entitled “FEE-BASED MESSAGE DELIVERY SYSTEMS”, which discloses a system and method for fee-based messaging over a global communications network, wherein a prospective recipient of messages establishes prices for a variety of services and for various tiers of senders; and

Gorodyansky United States Patent Application Publication No. US 2006/0265283, entitled “SYSTEM AND METHOD FOR MONETIZING INTERNET USAGE”, which discloses a toolbar incorporating software that collects, analyzes and protects information on user preferences determined based on the user's online activities, and wherein advertising is targeted to each user while the user's privacy is protected by storing all personal information on the user's local computer.

It is a desideratum of the present invention to avoid the shortcomings of the conventional and the aforementioned systems.

### SUMMARY OF THE INVENTION

The present invention provides a novel and unique method of controlling email address accounts, comprising the steps of: selling access to email addresses; approving email senders; approving email receivers; transmitting an email message; receiving said email message by means of a server; matching an approved sender to an approved receiver; forwarding the results of said matching step to said server; and delivering said email message to the approved receiver if said email message is approved.

The present invention additionally provides a novel and unique system for controlling email address accounts, the system comprising: a computer connected to a network and operable to send and receive email messages to and from the network; a memory connected to the computer; a server connected to the computer and the memory; a business ID framework application program stored in the memory and operable with the computer and the server to perform functions of matching an approved email sender to an approved email receiver and forwarding results to the server; and the server performing the functions of delivering the email message to the approved receiver if matched by the business ID framework application program, and blocking delivery of the email message if not matched by the business ID application program.

It is a primary object of the present invention to provide a method and system for controlling email address accounts.

Other objects, advantages, and features of the present invention will become apparent to those persons skilled in this particular area of technology and to other persons after having been exposed to the present patent application when read in conjunction with the accompanying patent drawing.

### BRIEF DESCRIPTION OF THE DRAWINGS

FIG. 1 illustrates a schematic diagram showing elements and operation of a method and system for controlling email address accounts in accordance with a first embodiment of the present invention.

FIG. 2 illustrates a schematic diagram showing elements and operation of a method and system for controlling email address accounts in accordance with a second embodiment of the present invention.

### DETAILED DESCRIPTION OF THE INVENTION

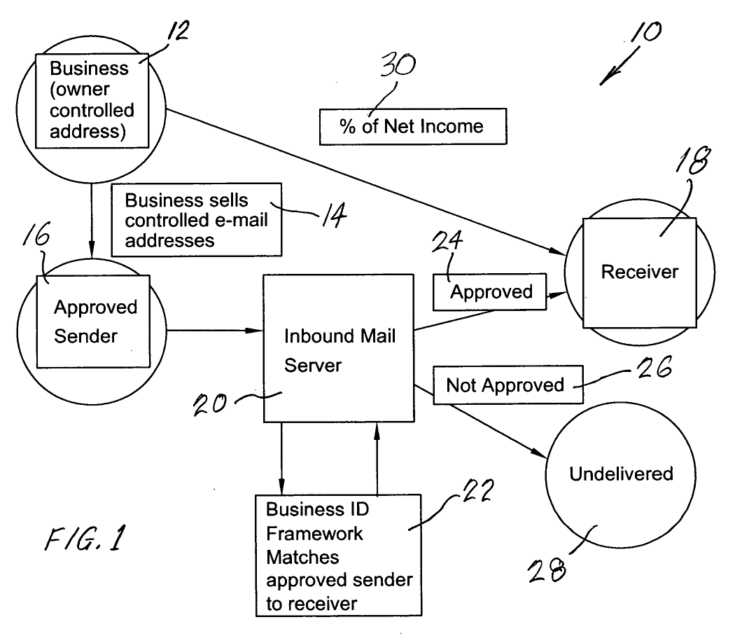

With reference to FIG. 1, there is illustrated a method and system 10 in accordance with a first embodiment of the present invention.

The invention provides a method and system 10 for controlling email address accounts.

With reference to FIG. 1, the method and system 10 provides for a business owner of controlled email addresses 12 to sell access to these controlled email addresses 14 for a specific period of time and/or a specific number of email messages.

The method and system 10 further operates in the following manner.

An approved sender 16 transmits an email message to an approved receiver 18.

An inbound email server 20 receives the incoming email message.

A business ID framework application program 22 matches an approved sender 16 to an approved receiver 18, and forwards the results to the server 20.

If the email message is approved 24, then it is delivered to the approved receiver 18.

If the email message is not approved 26, then it is undelivered 28.

Preferably, but not necessarily, the business owner of the controlled email addresses 12 will share a percentage of the net income 30 which is generated by address sales with approved receivers 18.

The present invention thus provides a method of controlling email address accounts, comprising the steps of: selling access to email addresses 14; approving email senders 16; approving email receivers 18; transmitting an email message; receiving said email message by means of a server 20; matching an approved sender 16 to an approved receiver 18; forwarding the results of said matching step to said server 22; and delivering said email message to the approved receiver 18 if said email message is approved.

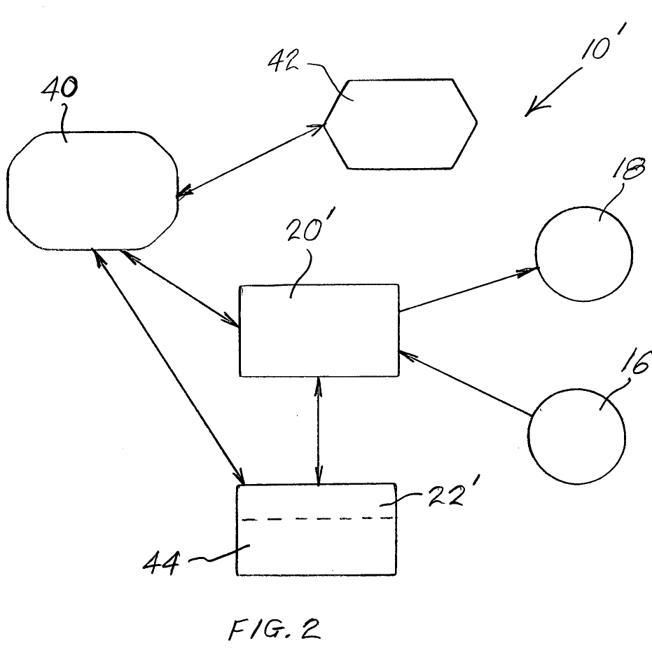

With reference to FIG. 2, the present invention also provides a system 10′ for controlling email address accounts 12, the system comprising: a computer 40 connected to a network 42 and operable to send and receive email messages to and from the network 42; a memory 44 connected to the computer 40; a server 20′ connected to the computer 40 and the memory 44; a business ID framework application program 22′ stored in the memory 44 and operable with the computer 40 and the server 20′ to perform functions of matching an approved email sender 16 to an approved email receiver 18 and forwarding results to the server 20′; and the server 20′ performing the functions of delivering the email message to the approved receiver 18 if matched by the business ID framework application program 22′, and blocking delivery of the email message if not matched by the business ID application program 22′.

Many variations of the above-described methods and systems can be utilized. For example, the system canset up email accounts which allow only paying advertisers into the system, with various exceptions. One such exception may be, for example, five incoming emailers at the email address owner's discretion.

There have been illustrated in the accompanying drawings and described hereinabove only several of the unique and novel embodiments of the present invention which can be practiced and constructed in many different configurations, and arrangements of components.

It should be understood that many changes, modifications, variations, and other uses and applications will become apparent to those persons skilled in this particular area of technology and to others after having been exposed to the present patent specification and accompanying drawings.

Any and all such changes, modifications, variations and other uses and applications which do not depart from the spirit and scope of the present invention are therefore covered by and embraced within the present invention and the patent claims as set forth hereinbelow.

1. A method of controlling email address accounts, comprising the steps of:
selling access to email addresses;
approving email senders;
approving email receivers;
transmitting an email message;
receiving said email message by means of a server;
matching an approved sender to an approved receiver;
forwarding the results of said matching step to said server; and
delivering said email message to the approved receiver if said email message is approved.

2. The method of controlling email address accounts according to claim 1, wherein:
said access to email addresses is sold for a specific period of time.

3. The method of controlling email address accounts according to claim 1, wherein:
said access to email addresses is sold for a specific number of email messages.

4. The method of controlling email address accounts according to claim 1, wherein:
said access to email addresses is sold for a specific period of time and/or a specific number of email messages.

5. The method of controlling email address accounts according to claim 1, wherein:
said selling step is done by a business owner of controlled email addresses.

6. The method of controlling email address accounts according to claim 2, wherein:
said selling step is done by a business owner of controlled email addresses.

7. The method of controlling email address accounts according to claim 3, wherein:
said selling step is done by a business owner of controlled email addresses.

8. The method of controlling email address accounts according to claim 4, wherein:
said selling step is done by a business owner of controlled email addresses.

9. The method of controlling email address accounts according to claim 1, wherein:
said transmitting step is done by the approved sender.

10. The method of controlling email address accounts according to claim 2, wherein:
said transmitting step is done by the approved sender.

11. The method of controlling email address accounts according to claim 3, wherein:
said transmitting step is done by the approved sender.

12. The method of controlling email address accounts according to claim 4, wherein:
said transmitting step is done by the approved sender.

13. The method of controlling email address accounts according to claim 5, wherein:
said transmitting step is done by the approved sender.

14. The method of controlling email address accounts according to claim 6, wherein:
said transmitting step is done by the approved sender.

15. The method of controlling email address accounts according to claim 7, wherein:
said transmitting step is done by the approved sender.

16. The method of controlling email address accounts according to claim 8, wherein:
said transmitting step is done by the approved sender.

17. The method of controlling email address accounts according to claim 5, including the step of:
sharing a percent of net income generated by said selling step by said business owner with the approved receivers.

18. (canceled)

19. The method of controlling email address accounts according to claim 16, including the step of:
sharing a percent of net income generated by said selling step by said business owner with the approved receivers.

20. A system for controlling email address accounts, the system comprising:
a computer connected to a network and operable to send and receive and receive email messages to and from the network;
a memory connected to the computer;
a server connected to the computer and the memory;
a business ID framework application program stored in the memory and operable with the computer and the server to perform functions of matching an approved email sender to an approved email receiver and forwarding results to the server; and
the server performing the functions of delivering the email message to the approved receiver if matched by the business ID framework application program, and blocking delivery of the email message if not matched by the business ID application program.

21. A method of controlling email address accounts, comprising the steps of:
approving email senders;
approving email receivers;
transmitting an email message;
receiving said email message by means of a server;
matching an approved sender to an approved receiver;
forwarding the results of said matching step to said server; and
delivering said email message to the approved receiver if said email message is approved.
